(19) United States
(12) Patent Application Publication
(10) Pub. No.: US 2016/0368351 A1
(43) Pub. Date: Dec. 22, 2016

(54) EXTENDABLE SUN VISOR

(71) Applicant: Parham Levi, Los Angeles, CA (US)

(72) Inventor: Parham Levi, Los Angeles, CA (US)

(21) Appl. No.: 14/744,519

(22) Filed: Jun. 19, 2015

(51) Int. Cl. B60J 3/02

(52) U.S. Cl. CPC B60J 3/0208

(57) ABSTRACT

An extendable sun visor includes a base portion and a cover portion. The cover portion first end is pivotably attached to the base portion first end where the cover portion is configured to pivot between a closed position and an open position in relation to the base portion. In the closed position the cover portion second end removably attaches to the base portion second end. A resilient clip is attached to a back base portion at the base portion second end, the back base portion opposite the inside base portion. A sun visor is attached at the base portion second end, the sun visor generally rectangular in shape comprising at least twelve inches in width and at least three inches in length, the length extending in a direction starting from the base portion second end and in a direction away from the base portion first end.

### CROSS-REFERENCE TO RELATED APPLICATIONS

None.

### DESCRIPTION

Field of the Invention

The present invention generally relates to sun visor. More particularly, the present invention relates to an extendable sun visor that also includes a sunglass holding clip.

Background of the Invention

It is desired that people reduce their risks from harmful ultraviolet (UV) radiation and protect their face and eyes from the sun while they drive or are outside. According to the World Health Organization (WHO), UV radiation is the main cause of skin cancer and it can cause wrinkles and blotchy skin. UV rays can also penetrate the structures of your eyes and cause cell damage. Common sun-related vision problems include cataracts and macular degeneration.

Accordingly, there is a need for a way to reduce UV radiation. The present invention fulfills these needs and provides other related advantages.

### SUMMARY OF THE INVENTION

An exemplary embodiment of an extendable sun visor includes a base portion defining a base portion first end opposite a base portion second end. A cover portion defines a cover portion first end opposite a cover portion second end, wherein the cover portion first end is pivotably attached to the base portion first end. The cover portion is configured to pivot between a closed position and an open position in relation to the base portion. In the closed position the cover portion second end removably attaches to the base portion second end. A resilient clip is attached to a back base portion at the base portion second end, the back base portion opposite the inside base portion. A sun visor is attached at the base portion second end, the sun visor generally rectangular in shape comprising at least twelve inches in width and at least three inches in length, the length extending in a direction starting from the base portion second end and in a direction away from the base portion first end.

In another embodiment a first resilient foam may be disposed on an inside base portion, where the inside base portion faces the cover portion. A second resilient foam may be disposed on an inside cover portion, where the inside cover portion faces the base portion. In the closed position the first resilient foam abuts the second resilient foam.

In another embodiment a flexural latch may be disposed at the base portion second end. A catch feature may be disposed at the cover portion second end. In the closed position the catch feature is captured by the flexural latch. The flexural latch may be integrally formed with the base portion. The flexural latch is manually actuated by a user.

In another embodiment the resilient clip may be a resilient and flexible metallic wire.

In another embodiment the sun visor may be a resiliently flexible wire forming a perimeter frame and a fabric attached to the perimeter frame. The fabric may form a pocket, where the resiliently flexible wire is disposed within the pocket. The fabric may be resiliently flexible.

The base portion may be an injection molded part. The cover portion may be an injection molded part.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a front perspective view of an exemplary embodiment of an extendable sun visor of the present invention in a closed position;

FIG. 2 is a view similar to FIG. 1 now with the extendable sun visor in an open position;

FIG. 3 is a rear perspective view of the structure of FIG. 1;

FIG. 4 is a front perspective view of the structure of FIG. 1 now with the fabric removed from the resiliently flexible perimeter frame wire;

FIG. 5 is an enlarged perspective view of the structure of FIG. 2 showing a catch and latch structure;

FIG. 6 is a side perspective view of the structure of FIG. 5, showing two inside foam portions and the resilient clip which attached to a visor or hat;

FIG. 7 is an enlarged perspective view of the structure of FIG. 5 showing the flexural latch structure; and

FIG. 8 is a perspective view of the structure of FIG. 1 in use attached to an automobile's visor and holding a pair of sunglasses.

### DETAILED DESCRIPTION OF THE PREFERRED EMBODIMENTS

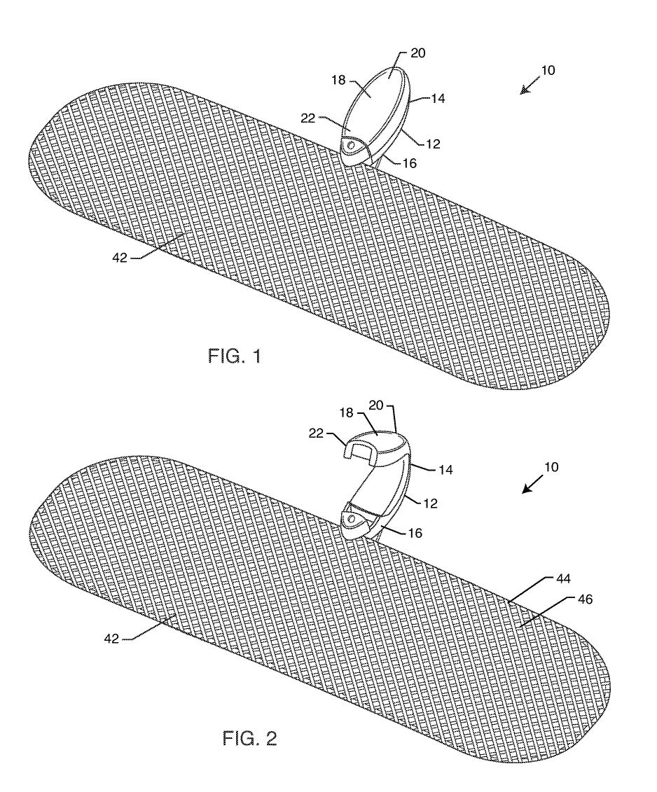

An exemplary embodiment of an extendable sun visor 10 includes a base portion 12 defining a base portion first end 14 opposite a base portion second end 16. A cover portion 18 defines a cover portion first end 20 opposite a cover portion second end 22, wherein the cover portion first end 20 is pivotably attached to the base portion first end 14. The pivot connection 30 is best seen in FIG. 6. The cover portion is configured to pivot between a closed position as shown in FIG. 1 and an open position in relation to the base portion as shown in FIG. 2.

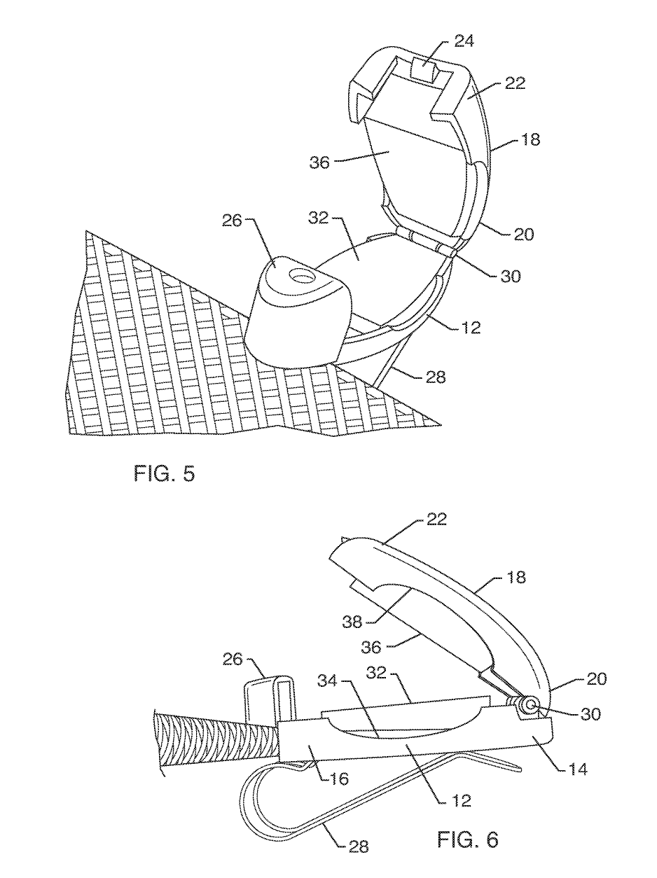

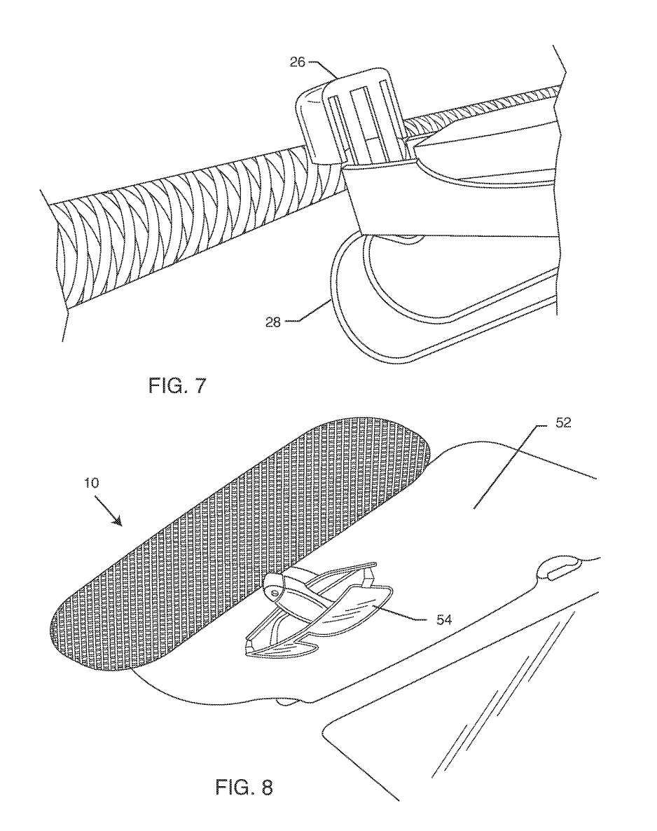

In the closed position the cover portion second end 22 is removably attached to the base portion second end 16. As best shown in FIGS. 5-7, a flexural latch 26 may be disposed at the base portion second end 16. A catch feature 24 may be disposed at the cover portion second end 22. In the closed position the catch feature 24 is captured by a flexural latch 26. The flexural latch 26 may be integrally formed with the base portion 12. For example, the flexural latch may be formed from a plastic that has enough internal flexibility such that the flexural latch 26 is manually actuated by a user. Not shown, it is also possible to form a latch 26 that uses a spring or elastic member to create a preload or bias.

As best shown in FIG. 6, a first resilient foam 32 may be disposed on an inside base portion 34, where the inside base portion 34 faces the cover portion 18. A second resilient foam 36 may be disposed on an inside cover portion 38, where the inside cover portion 38 faces the base portion 12. In the closed position the first resilient foam 32 abuts the second resilient foam 36 to then hold a pair of sunglasses within in a secure manner. The foams may be bonded to their respective portions, or attached with tapes or other means such as fasteners.

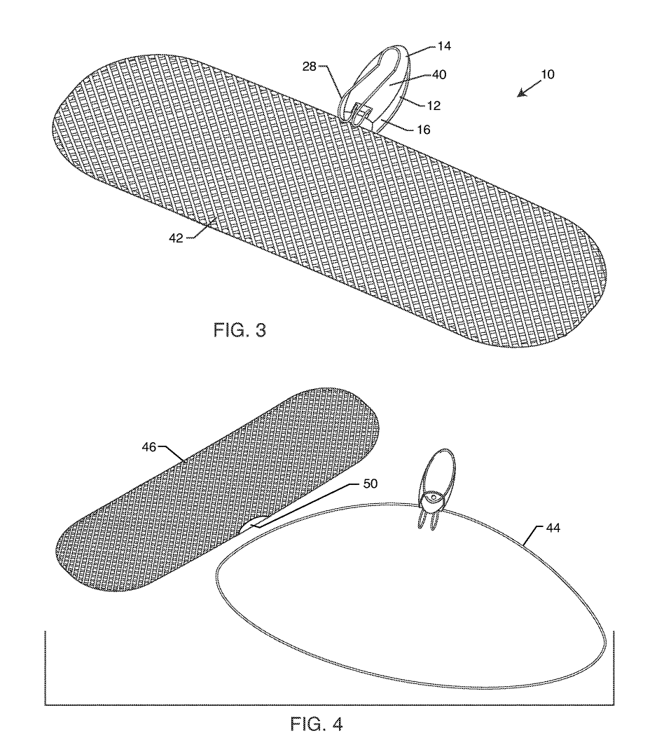

As shown in FIG. 3, a resilient clip 28 is attached to a back base portion 40 at the base portion second end 16. The back base portion 40 is opposite the inside base portion 34. The resilient clip 28 may be a resilient and flexible metallic wire. The resilient clip 28 can then be attached to a visor of an automobile or a visor of a hat, such as a baseball hat. The present invention 10 can then increase the amount of shade and provide an added safety benefit.

As shown in FIGS. 1-3, a sun visor 42 is attached at the base portion second end. The sun visor 42 is generally rectangular in shape comprising at least twelve inches in width 44 and at least three inches in length 46. The length extends in a direction starting from the base portion second end 16 and in a direction away from the base portion first end 14. The shape of the sun visor 42 as shown herein has rounded edges but can take many shapes and sizes. For instance the width can be at least 6, 9, 12 or 15 inches and the length can be at least 1, 2, 3 or 4 inches.

As best shown in FIG. 4, the sun visor 42 may be a resiliently flexible wire 44 forming a perimeter frame and a fabric 46 attached to the perimeter frame. The fabric 46 may form a pocket 50 with hole 48, where the resiliently flexible wire is disposed through the hole and within the pocket. The fabric 46 may be resiliently flexible. The fabric 46 may also be opaque or translucent, or a combination therebetween.

To simply manufacturing the invention, the base portion 12 and cover portion 18 may be an injection molded part. This reduces costs and increases production.

FIG. 8 is a perspective view of the extendable sun visor 10 in use attached to an automobile's visor 52 and holding a pair of sunglasses 54. The extendable sun visor can be clipped to a wide variety of structure and objects such as visors of automobiles but also hats or other thin structures where the clip 28 can grip and hold.

Although several embodiments have been described in detail for purposes of illustration, various modifications may be made to each without departing from the scope and spirit of the invention. Accordingly, the invention is not to be limited, except as by the appended claims.

### NUMERALS

extendable sun visor 10
base portion 12
base portion first end 14
base portion second end 16
cover portion 18
cover portion first end 20
cover portion second end 22
catch feature 24
flexural latch 26
resilient clip 28
pivot connection 30
first resilient foam 32
inside base portion 34
second resilient foam 36
inside cover portion 38
back base portion 40
sun visor 42
resiliently flexible wire 44
fabric 46
hole 48
pocket 50
automobile visor 52
sunglasses 54

What is claimed is:

1. An extendable sun visor, comprising:
a base portion defining a base portion first end opposite a base portion second end;
a cover portion defining a cover portion first end opposite a cover portion second end, wherein the cover portion first end is pivotably attached to the base portion first end, the cover portion configured to pivot between a closed position and an open position in relation to the base portion, wherein in the closed position the cover portion second end removably attaches to the base portion second end;
a resilient clip attached to a back base portion at the base portion second end, the back base portion opposite the inside base portion; and
a sun visor attached at the base portion second end.

2. The extendable sun visor of claim 1, including a first resilient foam disposed on an inside base portion, where the inside base portion faces the cover portion.

3. The extendable sun visor of claim 2, including a second resilient foam disposed on an inside cover portion, where the inside cover portion faces the base portion.

4. The extendable sun visor of claim 3, wherein in the closed position the first resilient foam abuts the second resilient foam.

5. The extendable sun visor of claim 1, including a flexural latch disposed at the base portion second end.

6. The extendable sun visor of claim 5, including a catch feature disposed at the cover portion second end.

7. The extendable sun visor of claim 6, wherein in the closed position the catch feature is captured by the flexural latch.

8. The extendable sun visor of claim 7, wherein the flexural latch is integrally formed with the base portion.

9. The extendable sun visor of claim 1, wherein the resilient clip comprises a resilient and flexible metallic wire.

10. The extendable sun visor of claim 1, wherein the sun visor comprises a resiliently flexible wire forming a perimeter frame and a fabric attached to the perimeter frame.

11. The extendable sun visor of claim 10, wherein the fabric comprises a pocket, where the resiliently flexible wire is disposed within the pocket.

12. The extendable sun visor of claim 10, wherein the fabric is resiliently flexible.

13. The extendable sun visor of claim 1, wherein the base portion comprises an injection molded part.

14. The extendable sun visor of claim 13, wherein the cover portion comprises an injection molded part.

15. The extendable sun visor of claim 8, wherein the flexural latch is manually actuated by a user.

16. The extendable sun visor of claim 1, wherein the sun visor is generally rectangular in shape comprising at least twelve inches in width and at least three inches in length, the length extending in a direction starting from the base portion second end and in a direction away from the base portion first end.

17. An extendable sun visor, comprising:
a base portion defining a base portion first end opposite a base portion second end;
a cover portion defining a cover portion first end opposite a cover portion second end, wherein the cover portion first end is pivotably attached to the base portion first end, the cover portion configured to pivot between a closed position and an open position in relation to the base portion, wherein in the closed position the cover portion second end removably attaches to the base portion second end;
a flexural latch disposed at the base portion second;
a catch feature disposed at the cover portion second end, wherein in the closed position the catch feature is captured by the flexural latch;
a resilient clip attached to a back base portion at the base portion second end, the back base portion opposite the inside base portion; and
a sun visor attached at the base portion second end, wherein the sun visor is generally rectangular in shape comprising at least twelve inches in width and at least three inches in length, the length extending in a direction starting from the base portion second end and in a direction away from the base portion first end.

18. The extendable sun visor of claim 17, including a first resilient foam disposed on an inside base portion, where the inside base portion faces the cover portion, and including a second resilient foam disposed on an inside cover portion, where the inside cover portion faces the base portion, wherein in the closed position the first resilient foam abuts the second resilient foam.

19. An extendable sun visor for an automobile or a hat, the extendable sun visor comprising:
a base portion defining a base portion first end opposite a base portion second end;
a cover portion defining a cover portion first end opposite a cover portion second end, wherein the cover portion first end is pivotably attached to the base portion first end, the cover portion configured to pivot between a closed position and an open position in relation to the base portion;
a first resilient foam disposed on an inside base portion, where the inside base portion faces the cover portion;
a second resilient foam disposed on an inside cover portion, where the inside cover portion faces the base portion;
wherein in the closed position the cover portion second end removably attaches to the base portion second end;
wherein in the closed position the first resilient foam abuts the second resilient foam;
a flexural latch disposed at the base portion second end;
a catch feature disposed at the cover portion second end;
wherein in the closed position the catch feature is captured by the flexural latch;
wherein the flexural latch is integrally formed with the base portion;
a resilient clip attached to a back base portion, the back base portion opposite the inside base portion;
wherein the resilient clip comprises a resilient and flexible metallic wire;
wherein the resilient clip is attached at the base portion second end;
a sun visor attached at the base portion second end, the sun visor generally rectangular in shape comprising at least eight inches in width and at least two inches in length, the length extending in a direction starting from the base portion second end and in a direction away from the base portion first end;
wherein the sun visor comprises a resiliently flexible wire forming a perimeter frame and a fabric attached to the perimeter frame; and
wherein the fabric comprises a pocket, where the resiliently flexible wire is disposed within the pocket.

20. The extendable sun visor of claim 19, wherein the base comprises an injection molded part and wherein the cover portion comprises an injection molded part.
